(19) United States
(12) Patent Application Publication
(10) Pub. No.: US 2012/0070732 A1
(43) Pub. Date: Mar. 22, 2012

(54) NEGATIVE ACTIVE MATERIAL FOR SECONDARY BATTERY, AND ELECTRODE AND SECONDARY BATTERY INCLUDING THE SAME

(76) Inventors: Jong-Sung Kim, Seoul (KR); Jeong-Hun Oh, Gyeonggi-do (KR); Chul Youm, Gyeonggi-do (KR); Kyung-Hee Han, Gyeonggi-do (KR); Jeong-Min Han, Gyeonggi-do (KR)

(21) Appl. No.: 12/937,224

(22) PCT Filed: Dec. 19, 2008
(86) PCT No.: PCT/KR2008/007548

§ 371 Date: May 26, 2011

(30) Foreign Application Priority Data
Apr. 11, 2008 (KR) 10-2008-0033793

(51) Int. Cl. H01M 4/583; H01M 4/66

(52) U.S. Cl. 429/211; 429/231.8

(57) ABSTRACT

A negative active material for a secondary battery includes a core carbon material, and a carbide layer formed on at least a portion of an edge of the core carbon material, and has a specific surface area ratio of 1.6 or less and a sphericity ratio of 0.6 or more when the negative active material is compressed with a pressure of 1.3 ton per 1 cm² for 2 seconds. A secondary battery manufactured using the negative active material can prevent deterioration of characteristics caused by destruction of the carbide layer and deformation of core carbon material that may occur during a compression process performed to manufacture an electrode for the secondary battery. As a result, the secondary battery can be improved in aspect of a discharging capacity, a cycle efficiency and a discharging capacity retention rate at a long cycle.

### TECHNICAL FIELD

The present invention relates to a negative active material for a secondary battery, and in particular, to a negative active material for a secondary battery, in which at least a portion of an edge of a core carbon material is coated with a carbide layer, and to an electrode of a secondary battery and a secondary battery including the same.

### BACKGROUND ART

With rapid popularization of electronic appliances using batteries in these days, for example, mobile phones, notebook computers or electric vehicles, the demand for secondary batteries of small size, light weight and relatively high capacity is rapidly increasing. In particular, a lithium secondary battery has light weight and high energy density, and thus is widely used as a power source of a portable electronic appliance. Accordingly, research and development is lively made to improve the performance of the lithium secondary battery.

The lithium secondary battery includes an anode and a cathode, each containing an active material capable of intercalating and deintercalating lithium ions, and an organic electrolytic solution or polymer electrolytic solution filled therebetween. The lithium secondary battery generates electric energy by oxidation and reduction reactions during intercalation and deintercalation of lithium ions at the anode and the cathode.

The lithium secondary battery uses mainly a transition metal compound as an active material for a cathode, for example LiCoO₂, LiNiO₂ or LiMnO₂.

And, the lithium secondary battery uses, as an active material for an anode, a crystalline carbon material having high softness, for example natural graphite or artificial graphite, or a low crystalline carbon material having a pseudo-graphite structure or turbostratic structure, obtained by carbonizing hydrocarbon or polymer at a low temperature of 1000° C. to 1500° C.

The crystalline carbon material has a high level of true density that is advantageous to pack an active material, and has excellent electric potential flatness, initial capacity and charging/discharging reversibility. However, as the number of times a battery is used increases, charging/discharging efficiency and cycle capability reduces. According to analysis, this is because when battery charging/discharging cycles are repeated, decomposition of an electrolytic solution occurs at an edge of the crystalline carbon material.

Japanese Patent Laid-open Publication No. 2002-348109 discloses a carbon material-based negative active material, in which a crystalline carbon material is coated with a carbide layer to prevent decomposition of an electrolytic solution from occurring at an edge of the crystalline carbon material. In the carbon material-based negative active material, the carbide layer is formed by coating pitch on the surface of the carbon material and performing thermal treatment at 1000° C. or more. Here, coating of the carbon material with the carbide layer reduces slightly an initial capacity of a secondary battery, but improves charging/discharging efficiency and cycle capacity of the secondary battery. In particular, high temperature thermal treatment makes the coating layer an artificial graphite to reduce a reduction amount of initial capacity and effectively suppress decomposition of an electrolytic solution.

However, while manufacturing an electrode of a secondary battery by coating the carbon material-based negative active material on a metallic current collector, coating effect of the carbide layer is reduced. In the manufacture of an electrode of a secondary battery, a compression process is performed to closely bond the negative active material and the metallic current collector. However, during the compression process, the carbide layer coated on the edge of the carbon material is destroyed to expose the edge of the carbon material again, resulting in decomposition of an electrolytic solution.

Therefore, in the manufacture of an electrode of a secondary battery using the conventional carbon material-based negative active material, it needs to newly define property parameters of the negative active material and clearly understand the correlation between the defined property parameters and electrical and chemical characteristics of the secondary battery so as to prevent deterioration of the electrical and chemical characteristics of the secondary battery caused by destruction of the carbide layer.

However, the above-mentioned prior art simply specifies a mass ratio between the carbon material and the carbide layer, coating and sintering conditions of the carbide layer, crystallographic properties of the carbide layer through XRD (X-Ray Diffraction) and Raman analysis and specific surface area conditions of the carbide layer, to effectively suppress a decomposition reaction of an electrolytic solution, but not mention any problem caused by destruction of the carbide layer that may occur in the course of manufacturing an electrode of a secondary battery, and the solution to overcome deterioration of the carbide layer.

### DISCLOSURE OF INVENTION

### Technical Problem

The present invention is designed to solve the above-mentioned problems. Therefore, it is an object of the present invention to provide a carbon material-based negative active material for a secondary battery with such property parameter values as to prevent deterioration of electrical and chemical characteristics of the secondary battery during a compression process performed to manufacture an electrode of the secondary battery by newly defining property parameters of the negative active material and understanding the correlation between the defined property parameters and electrical and chemical characteristics of the secondary battery.

It is another object of the present invention to provide an electrode of a secondary battery manufactured using the carbon material-based negative active material with optimum values of the newly defined property parameters, and a secondary battery including the same.

### Technical Solution

In order to achieve the above-mentioned objects, a negative active material for a secondary battery according to the present invention includes a core carbon material, and a carbide layer formed on at least a portion of an edge of the core carbon material, and the negative active material has a specific surface area ratio of 1.6 or less and a sphericity ratio of 0.6 or more between before and after compression with a pressure of 1.3 ton per 1 cm² for 2 seconds.

In order to achieve the above-mentioned objects, an electrode of a secondary battery according to the present invention includes a metallic current collector and a negative active material coated on the metallic current collector, wherein the negative active material has a specific surface area ratio of 1.6 or less and a sphericity ratio of 0.6 or more between before and after compression with a pressure of 1.3 ton per 1 cm² for 2 seconds.

In order to achieve the above-mentioned objects, a secondary battery according to the present invention includes an anode current collector coated with a negative active material; a cathode current collector coated with a positive active material; a separator interposed between the anode current collector and the cathode current collector; and an electrolytic solution filled in the separator, wherein the negative active material has a specific surface area ratio of 1.6 or less and a sphericity ratio of 0.6 or more between before and after compression with a pressure of 1.3 ton per 1 cm² for 2 seconds.

In the present invention, the specific surface area ratio is defined as a ratio of a specific surface area after the compression to a specific surface area before the compression when a pressure of 1.3 ton per 1 cm² is applied to the negative active material. And, the sphericity ratio is defined as a ratio of sphericity after the compression to sphericity before the compression when a pressure of 1.3 ton per 1 cm² is applied to the negative active material.

Preferably, the specific surface area is defined as a specific surface area value measured by a ‘Tristar 3000™ specific surface area analyser’ produced by Micromeritics. And, the sphericity is defined as (I(110)/I(004)), a ratio of I(110) to I(004) of the negative active material, measured by ‘X'pert Pro MPD XRD (X-Ray Diffraction) system’ produced by Philips. Here, I(110) and I(004) are diffraction intensities of 110 plane and 004 plane, respectively, in XRD measurement results of the negative active material.

In the negative active material according to the present invention, the core carbon material is preferably a high crystalline natural graphite having a spherical shape.

Alternatively, the core carbon material may be any one selected from the group consisting of natural graphite having an oval, wavy, scale-like or whisker-like shape, artificial graphite, mesocarbonmicro beads, mesophase pitch fine powder, isotropic pitch fine powder and resin coal, and low crystalline carbon fine powder having a pseudo-graphite structure or turbostratic structure, or mixtures thereof.

Preferably, the carbide layer is a low crystalline carbide layer formed by coating the core carbon material with pitch or tar derived from coal or petroleum, or mixtures thereof and performing carbonization of the coated layer.

A secondary battery manufactured using the negative active material according to the present invention has a discharging capacity of 345 mAh/g or more and a cycle efficiency of 92% or more.

### MODE FOR THE INVENTION

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

A negative active material for a secondary battery according to the preferred embodiments of the present invention includes a core carbon material, and a carbide layer formed on at least a portion of an edge of the core carbon material, and has a specific surface area ratio of 1.6 or less and a sphericity ratio of 0.6 or more.

Preferably, the core carbon material is preferably a high crystalline natural graphite having a spherical shape. Alternatively, the core carbon material may be any one selected from the group consisting of natural graphite having an oval, wavy, scale-like or whisker-like shape, artificial graphite, mesocarbonmicro beads, mesophase pitch fine powder, isotropic pitch fine powder and resin coal, and low crystalline carbon fine powder having a pseudo-graphite structure or turbostratic structure, or mixtures thereof.

Preferably, the carbide layer is a low crystalline carbide layer formed by coating the core carbon material with pitch or tar derived from coal or petroleum, or mixtures thereof and performing carbonization of the coated layer. Here, the low crystalline means that crystallinity of the carbide layer is lower than crystallinity of the core carbon material. The carbide layer fills up micropores of the core carbon material to decrease a specific surface area and reduce a site where decomposition of an electrolytic solution may occur.

In the present invention, the specific surface area ratio is defined as a ratio of a specific surface area after compression to a specific surface area before compression when the negative active material is compressed. And, the sphericity ratio is defined as a ratio of sphericity after compression to sphericity before compression when the negative active material is compressed.

Here, compression is performed such that 2 g of the negative active material is put into a hole cup of Φ1.4 cm and a force of 2 t is applied to the area of Φ1.4 cm using a press machine for 2 seconds. Under this condition, the negative active material is compressed with a pressure of 1.3 ton per 1 cm² for 2 seconds. The used compression equipment is ‘WE-3C6-02G-A2-20’ press machine produced by Unipack.

Formulae for calculating the specific surface area ratio and sphericity ratio are represented as the following Math Figures 1 and 2.

MathFigure 1

Sᵣ=Sₐ/S_{f} [Math.1]

where Sᵣ is a specific surface area ratio of the negative active material, Sₐ is a specific surface area after compression of the negative active material, and S_{f} is a specific surface area before compression of the negative active material.

MathFigure 2

Xᵣ=Xₐ/X_{f} [Math.2]

where Xᵣ is a sphericity ratio of the negative active material, Xₐ is sphericity after compression of the negative active material, and X_{f} is sphericity before compression of the negative active material.

In the above Math Figure 1, the specific surface area of the negative active material is defined as a specific surface area value measured ‘Tristar 3000™ specific surface area analyser’ produced by Micromeritics.

In the above Math Figure 2, the sphericity of the negative active material is defined as (I(110)/I(004)), a ratio of I(110) to I(004) of the negative active material, measured by ‘X'pert Pro MPD XRD (X-Ray Diffraction) system’ produced by Philips. Here, I(110) and I(004) are diffraction intensities of 110 plane and 004 plane, respectively, in XRD measurement results of the negative active material.

In the case that the specific surface area ratio Sᵣ is more than 1.6, it is not preferable because a cycle capacity, cycle efficiency and a capacity retention rate at a long cycle of a secondary battery is rapidly deteriorated due to excessive exposure of the edge of the core carbon material where an electrolytic solution reacts, caused by partial destruction of the carbide layer coated on a portion or the whole of the edge of the core carbon material during compression of the negative active material performed to coat the negative active material on a metallic current collector.

And, in the case that the specific surface area ratio Sᵣ is less than 0.6, it is not preferable because a cycle capacity, a cycle efficiency and a capacity retention rate at a long cycle of a secondary battery is rapidly deteriorated due to exposure of the surface of the edge of the core carbon material where an electrolytic solution reacts, or reduction of electrode density, caused by failure to maintain the spherical shape of the core carbon material and deformation of the core carbon material during compression of the negative active material performed to coat the negative active material on a metallic current collector.

The negative active material for a secondary battery according to the present invention can be prepared by the steps of forming a carbon material coating layer on a granular core carbon material by wet-mixing or dry-mixing the core carbon material with a carbon material derived from coal or petroleum, and sintering the core carbon material having the carbon material coating layer, so that at least a portion of an edge of the core carbon material is coated with a carbide layer.

Preferably, the core carbon material is a high crystalline natural graphite having a spherical shape. Alternatively, the core carbon material may be any one selected from the group consisting of natural graphite having an oval, wavy, scale-like or whisker-like shape, artificial graphite, mesocarbonmicro beads, mesophase pitch fine powder, isotropic pitch fine powder and resin coal, and low crystalline carbon fine powder having a pseudo-graphite structure or turbostratic structure, or mixtures thereof.

Preferably, the carbon material derived from coal or petroleum is pitch, tar, or mixtures thereof.

Preferably, in the manufacture of the negative active material according to the present invention, a mixing weight ratio between the core carbon material and the carbon material derived from coal and petroleum, a sintering temperature increase speed, a sintering temperature or a sintering time is controlled such that crystallinity of the carbide layer is lower than crystallinity of the core carbon material, and a specific surface area ratio and a sphericity ratio of the negative active material is 1.6 or less and 0.6 or more, respectively.

If necessary, the specific surface area ratio and the sphericity ratio of the negative active material may be further controlled by mixing the negative active material prepared according to the present invention with a core carbon material not coated with a carbide layer.

The negative active material for a secondary battery prepared by the above-mentioned process may be mixed with a conductive material, a binder and an organic solvent into an active material paste. The active material paste may be applied to a metallic current collector such as a copper foil current collector, and then may be dried, thermally treated and compressed to manufacture an electrode (anode) of a secondary battery.

And, the electrode of a secondary battery manufactured as mentioned above may be used in manufacturing a lithium secondary battery. That is, a rechargeable lithium secondary battery may be manufactured by placing a metallic current collector bonded with a predetermined thickness of the negative active material of the present invention and a metallic current collector bonded with a predetermined thickness of Li-based transition metal compound on the opposite sides of a separator, and impregnating the separator with an electrolytic solution for a lithium secondary battery. The methods for manufacturing an electrode of a secondary battery and a secondary battery including the same are well known to persons having ordinary skill in the art, and their detailed description is omitted.

Meanwhile, the present invention is characterized by properties of a negative active material for a secondary battery. Thus, an electrode of a secondary battery and a secondary battery including the same can be manufactured using the negative active material of the present invention by various methods well known in the art. And, it is obvious that a secondary battery manufactured using the negative active material of the present invention is not limited to a lithium secondary battery.

### EXAMPLES

### Example 1

Natural spherical graphite was wet-mixed with 5 weight % of pitch dissolved in tetrahydrofuran, relative to weight of the natural graphite, at normal pressure for 2 hours or more, and dried to obtain a mixture of the graphite and the pitch. The mixture was inserted into a sintering chamber, and sintered at 1100° C. for 1 hour after increasing the temperature to 1100° C. at a temperature increase speed of 1° C./min. Fine powder removal and powder classification was performed to obtain a negative active material. The measurement results showed that the negative active material of example 1 had a specific surface ratio of 1.28 and a sphericity ratio of 0.75.

### Example 2

A negative active material was prepared in the same way as example 1, except that 10 weight % of pitch was used relative to weight of the natural graphite and the temperature increase speed for mixture sintering was 3° C./min. The measurement results showed that the negative active material of example 2 had a specific surface ratio of 1.48 and a sphericity ratio of 0.65.

### Example 3

A negative active material was prepared in the same way as example 1, except that 20 weight % of pitch was used relative to weight of the natural graphite and the temperature increase speed was 10° C./min. Next, 30 weight % of natural spherical graphite not coated with a carbide layer was added relative to weight of the negative active material. The measurement results showed that the negative active material of example 3 had a specific surface ratio of 1.21 and a sphericity ratio of 0.87.

### Example 4

A negative active material was prepared in the same way as example 1, except that 20 weight % of pitch was used relative to weight of the natural graphite and the temperature increase speed was 10° C./min. Next, 50 weight % of natural spherical graphite not coated with a carbide layer was added relative to weight of the negative active material. The measurement results showed that the negative active material of example 4 had a specific surface ratio of 1.14 and a sphericity ratio of 0.94.

### Comparative Example 1

A negative active material was prepared in the same way as example 1, except that 15 weight % of pitch was used relative to weight of the natural graphite and the temperature increase speed was 10° C./min. The measurement results showed that the negative active material of comparative example 1 had a specific surface ratio of 1.68 and a sphericity ratio of 0.51.

### Comparative Example 2

A negative active material was prepared in the same way as example 1, except that 20 weight % of pitch was used relative to weight of the natural graphite and the temperature increase speed was 10° C./min. The measurement results showed that the negative active material of comparative example 2 had a specific surface ratio of 1.75 and a sphericity ratio of 0.43.

<Manufacture of an Electrode of a Secondary Battery and a Coin Cell>

An electrode of a secondary battery was manufactured using each negative active material prepared according to examples 1 to 4 and comparative examples 1 and 2. First, 100 g of a negative active material was put into a 500 mg reactor, and a small amount of N-methylpyrrolidone (NMP) and a binder (PVDF) were added. They were mixed by a mixer. The mixture was coated on a copper foil for an anode current collector, dried, heated and compressed with density of 1.65 g/cm³ to manufacture an anode of a secondary battery. And, 2016 coin cell battery was manufactured using each anode manufactured according to examples 1 to 4 and comparative examples 1 and 2 and a Li electrode (an opposite electrode), and then tested to evaluate charging/discharging characteristics of the negative active material.

<Evaluation of Charging/Discharging Characteristics of a Coin Cell>

A charging/discharging test was performed from 1st cycle to 25th cycle. The charging and discharging test was performed each cycle such that voltage was controlled to the range of 0.01 to 1.5V, and charging was made with a charging current of 0.5 mA/cm² until voltage is 0.01V and continued until the charging current is 0.02 mA/cm² while maintaining the voltage at 0.01V, and discharging was made with a discharging current of 0.5 mA/cm².

The following Table 1 shows the measurement results about a specific surface area ratio and a sphericity ratio of each negative active material prepared according to examples 1 to 4 and comparative examples 1 and 2 and charging/discharging characteristics of a coin cell manufactured using each negative active material. In Table 1, note that a discharging capacity retention rate is measured at 25th cycle based on a discharging capacity at 2nd cycle.

TABLE 1

| | | | | | | | | | Capacity |
|---|---|---|---|---|---|---|---|---|---|
| | | | | | | | | | retention |
| | | Specific | | | | | | | rate |
| | Specific | surface | | | | | | | (@ discharging |
| | surface | area | | | | | Discharging | Efficiency | capacity |
| | area | after | Specific | Sphericity | Sphericity | | capacity | at | at |
| | before | compression | surface | before | before | Sphericity | at 1st | 1st | 25th |
| | compression | (2) | area | compression | compression | ratio | cycle | cycle | cycle) |
| [symbol] | (1)(m²/g) | (m²/g) | ratio | (A) | (B) | (B)/(A) [symbol] | (mAh/g) | (%) | (%) |
| Example 1 | 2.54 | 3.25 | 1.28 | 35.96 | 26.97 | 0.75 | 354 | 93.6 | 96.3 |
| Example 2 | 1.87 | 2.77 | 1.48 | 34.37 | 22.34 | 0.65 | 348 | 93.8 | 91.5 |
| Example 3 | 1.79 | 2.17 | 1.21 | 37.40 | 32.54 | 0.87 | 347 | 93.4 | 93.1 |
| Example 4 | 2.05 | 2.34 | 1.14 | 38.89 | 36.56 | 0.94 | 351 | 93.6 | 95.3 |
| Comparative | 1.35 | 2.27 | 1.68 | 34.35 | 17.52 | 0.51 | 344 | 91.0 | 79.3 |
| example 1 | | | | | | | | | |
| Comparative | 1.14 | 2.00 | 1.75 | 33.88 | 14.57 | 0.43 | 339 | 91.1 | 72.2 |
| example 2 | | | | | | | | | |

Referring to the above Table 1, it is found that a specific surface area ratio and a sphericity ratio before and after compression is related to performance of a secondary battery. That is, as a specific surface area ratio is larger and a sphericity ratio is smaller, a discharging capacity (initial capacity) and efficiency at 1st cycle and a discharging capacity retention rate at 25th cycle is rapidly deteriorated.

Here, an increase in a specific surface area ratio means that a surface area of natural graphite has been newly exposed due to destruction of a carbide layer coated on the natural graphite during a compression process performed to meet the electrode density requirements. And, a reduction in a sphericity ratio means that a portion of natural graphite has not maintained its spherical shape and has destroyed during a compression process performed to meet the electrode density requirements.

It is found through Table 1 that each negative active material according to examples 1 to 4 with a specific surface area ratio of 1.6 or less and a sphericity ratio of 0.6 or more has higher discharging capacity and efficiency at 1st cycle and discharging capacity retention rate at 25th cycle than comparative examples 1 and 2, leading to excellent battery performance. That is, if a specific surface area ratio is 1.6 or less and a sphericity ratio is 0.6 or more, a secondary battery has an efficiency of 93% or more at 1st cycle and a capacity retention rate of 90% or more at 25th cycle. But, if a specific surface area ratio is more than 1.6 and a sphericity ratio is less than 0.6, a secondary battery has an efficiency of less than 92% at 1st cycle and a capacity retention rate of less than 80% at 25th cycle.

Meanwhile, it is found that examples 3 and 4 and comparative examples 1 and 2 used similar pitch content and temperature increase speed, but showed significant differences in a specific surface area ratio and a sphericity ratio according to use of an additive (natural graphite not coated with a carbide layer). It is analyzed that natural graphite used as an additive is softer than natural graphite coated with a carbide layer and serves as a buffer during a compression process performed to meet the electrode density requirements to prevent the natural graphite coated with the carbide layer from running into each other and destroying.

As such, the preferred embodiments of the present invention are described in detail with reference to the accompanying drawings. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

A secondary battery manufactured using the negative active material according to the present invention can prevent deterioration of characteristics caused by destruction of a carbide layer and deformation of a core carbon material that may occur during a compression process performed to manufacture an electrode of the secondary battery. As a result, the secondary battery has the improved discharging capacity, cycle efficiency and discharging capacity retention rate at a long cycle.

1. A negative active material for a secondary battery, comprising: a core carbon material; and a carbide layer formed on at least a portion of an edge of the core carbon material, wherein the negative active material has a specific surface area ratio of 1.6 or less and a sphericity ratio of 0.6 or more when the negative active material is compressed with a pressure of 1.3 ton per 1 cm² for 2 seconds.

2. The negative active material for a secondary battery according to claim 1, wherein the specific surface area ratio is defined as a ratio of a specific surface area after the compression to a specific surface area before the compression, and wherein the sphericity ratio is defined as a ratio of sphericity after the compression to sphericity before the compression.

3. The negative active material for a secondary battery according to claim 2, wherein the specific surface areas before and after the compression are measured by a ‘Tristar 3000™ specific surface area analyser’ produced by Micromeritics.

4. The negative active material for a secondary battery according to claim 2, wherein the sphericities before and after the compression are defined as 1(110)/I(004), a ratio of 1(110) to 1(004) measured by ‘Xpert Pro MPD XRD (X-Ray Diffraction) system’ produced by Philips.

5. The negative active material for a secondary battery according to claim 1, wherein the core carbon material is a high crystalline natural graphite having a spherical shape.

6. The negative active material for a secondary battery according to claim 1, wherein the core carbon material is any one selected from the group consisting of natural graphite having an oval, wavy, scale-like or whisker-like shape, artificial graphite, mesocarbonmicro beads, mesophase pitch fine powder, isotropic pitch fine powder and resin coal, and low crystalline carbon fine powder having a pseudo-graphite structure or turbostratic structure, or mixtures thereof.

7. The negative active material for a secondary battery according to claim 1, wherein the carbide layer is a low crystalline carbide layer formed by coating the core carbon material with pitch or tar derived from coal or petroleum, or mixtures thereof and performing carbonization of the coated layer.

8. The negative active material for a secondary battery according to claim 1, further comprising: natural spherical graphite not coated with a carbide layer.

9. An electrode of a secondary battery, comprising: a metallic current collector coated with the negative active material defined in claim 1.

10. An electrode of a secondary battery, comprising:
a metallic current collector coated with the negative active material defined in claim 2.

11. An electrode of a secondary battery comprising: a metallic current collector coated with the negative active material defined in claim 3.

12. An electrode of a secondary battery, comprising: a metallic current collector coated with the negative active material defined in claim 4.

13. A secondary battery, comprising:
an anode current collector coated with the negative active material defined in claim 1;
a cathode current collector coated with a positive active material;
a separator interposed between the anode current collector and the cathode current collector; and
an electrolytic solution filled in the separator.

14. A secondary battery, comprising:
an anode current collector coated with the negative active material defined in claim 2;
a cathode current collector coated with a positive active material;
a separator interposed between the anode current collector and the cathode current collector; and
an electrolytic solution filled in the separator.

15. A secondary battery, comprising:
an anode current collector coated with the negative active material defined in claim 3;
a cathode current collector coated with a positive active material;
a separator interposed between the anode current collector and the cathode current collector; and
an electrolytic solution filled in the separator.

16. A secondary battery, comprising:
an anode current collector coated with the negative active material defined in claim 4;
a cathode current collector coated with a positive active material;
a separator interposed between the anode current collector and the cathode current collector; and
an electrolytic solution filled in the separator.

17. The secondary battery according to claim 13, wherein the secondary battery has a discharging capacity of 345 mAh/g or more and a cycle efficiency of 92% or more.

18. The secondary battery according to claim 14, wherein the secondary battery has a discharging capacity of 345 mAh/g or more and a cycle efficiency of 92% or more.

19. The secondary battery according to claim 15, wherein the secondary battery has a discharging capacity of 345 mAh/g or more and a cycle efficiency of 92% or more.

20. The secondary battery according to claim 16, wherein the secondary battery has a discharging capacity of 345 mAh/g or more and a cycle efficiency of 92% or more.
